(19) United States
(12) Patent Application Publication
(10) Pub. No.: US 2020/0024183 A1
(43) Pub. Date: Jan. 23, 2020

(54) SUBSTRATE COATING APPARATUS AND METHODS

(71) Applicant: CORNING INCORPORATED, CORNING, NY (US)

(72) Inventors: Gabriel Pierce Agnello, Corning, NY (US); William John Bub, III, Ontario, NY (US); Jia Zhang, Painted Post, NY (US)

(21) Appl. No.: 16/497,567

(22) PCT Filed: Mar. 26, 2018
(86) PCT No.: PCT/US18/24243

§ 371 Date: Sep. 25, 2019

Related U.S. Application Data
(60) Provisional application No. 62/478,284, filed on Mar. 29, 2017.

(51) Int. Cl. C03C 15/00; B05C 1/08

(52) U.S. Cl. CPC C03C 15/00; B05C 1/0808

(57) ABSTRACT

A Substrate coating apparatus can include a container including a reservoir and an adjustable dam defining an adjustable depth of the reservoir. The apparatus can further include a roller rotatably mounted relative to the container. A portion of an outer periphery of the roller can be disposed within the adjustable depth of the reservoir. A method of coating a substrate can include filling a reservoir of a container with a liquid and contacting a portion of an outer periphery of a roller with the liquid at a contact angle. The method can further include changing an elevation of a free surface of the liquid within the reservoir to change the contact angle. The method can still include rotating the roller about a rotation axis to transfer liquid from the reservoir to a major surface of the substrate.

### CROSS-REFERENCE TO RELATED APPLICATIONS

This application claims the benefit of priority of U.S. Provisional Application Ser. No. 62/478,284 filed on Mar. 29, 2017 the contents of which are relied upon and incorporated herein by reference in their entirety as if fully set forth below.

### FIELD

The present disclosure relates generally to substrate coating apparatus and methods and, more particularly, to substrate coating apparatus including an adjustable dam and methods of coating a substrate including changing an elevation of a free surface of liquid within a reservoir.

### BACKGROUND

It is known to coat a major surface of a substrate with an etchant designed to etch the major surface of the substrate. There is a desire to provide apparatus and methods that allow control the transfer rate of a liquid (e.g., etchant) to a major surface of a substrate (e.g., a glass sheet).

### SUMMARY

The following presents a simplified summary of the disclosure to provide a basic understanding of some embodiments described in the detailed description.

### Embodiment 1

A substrate coating apparatus can include a container comprising a reservoir and an adjustable dam defining an adjustable depth of the reservoir. The apparatus can also include a roller rotatably mounted relative to the container. A portion of an outer periphery of the roller can be disposed within the adjustable depth of the reservoir.

### Embodiment 2

The substrate coating apparatus of embodiment 1, wherein the apparatus can further include a liquid disposed in the reservoir with a free surface of the liquid extending over an upper edge of the adjustable dam, and the roller contacting the liquid at a contact angle.

### Embodiment 3

The substrate coating apparatus of embodiment 2, wherein the liquid may include an etchant.

### Embodiment 4

The substrate coating apparatus of embodiment 2 or embodiment 3, wherein adjusting the adjustable dam can change an elevation of the free surface.

### Embodiment 5

The substrate coating apparatus of any one of embodiments 2-4, wherein the contact angle can be from 90° to less than 180°.

### Embodiment 6

The substrate coating apparatus of any one of embodiments 2-5, wherein the portion of the outer periphery of the roller can extend to a submerged depth below the free surface from 0.5 mm to 50% of a diameter of the roller.

### Embodiment 7

The substrate coating apparatus of any one of embodiments 1-5, wherein a diameter of the roller can be from about 20 mm to about 50 mm.

### Embodiment 8

The substrate coating apparatus of any one of embodiments 1-7, wherein the outer periphery of the roller can be defined by a porous material.

### Embodiment 9

The substrate coating apparatus of any one of embodiments 1-8, wherein the reservoir can include a first end portion and a second end portion opposed to the first end portion, and the second end portion can be at least partially defined by the adjustable dam.

### Embodiment 10

The substrate coating apparatus of embodiment 9, wherein a depth of the reservoir corresponding to an adjusted position of the adjustable dam can increase in a direction from the first end portion to the second end portion.

### Embodiment 11

The substrate coating apparatus of embodiment 9, wherein a rotation axis of the roller can extend in a direction from the first end portion to the second end portion.

### Embodiment 12

The substrate coating apparatus of any one of embodiments 9-11, wherein the apparatus can further include an inlet port that opens into the first end portion of the reservoir.

### Embodiment 13

The substrate coating apparatus of embodiment 12, wherein the apparatus can further include an outlet port that opens into the second end portion of the reservoir.

### Embodiment 14

The substrate coating apparatus of embodiment 12, wherein the adjustable dam can be positioned between an outlet port and the inlet port.

### Embodiment 15

A method of coating a substrate can include filling a reservoir of a container with a liquid. The method can further include contacting a portion of an outer periphery of a roller with the liquid at a contact angle. The method can still further include changing an elevation of a free surface of the liquid within the reservoir to change the contact angle. The method can also include rotating the roller about a rotation axis to transfer liquid from the reservoir to a major surface of the substrate.

### Embodiment 16

The method of embodiment 15, wherein rotating the roller can lift the transferred liquid from the reservoir to contact the major surface of the substrate.

### Embodiment 17

The method of embodiment 15 or embodiment 16, wherein the major surface of the substrate can be spaced above the free surface and face the free surface.

### Embodiment 18

The method of any one of embodiments 15-17, wherein the contact angle can be from 90° to less than 180°.

### Embodiment 19

The method of any one of embodiments 15-18, wherein a portion of the transfer liquid can space the substrate from contacting the roller while transferring the liquid from the reservoir to the major surface of the substrate.

### Embodiment 20

The method of any one of embodiments 15-19, wherein changing the elevation of the free surface can include adjusting a height of an adjustable dam.

### Embodiment 21

The method of any one of embodiments 15-19, wherein the method can further include increasing a rate of the liquid transfer by raising an upper edge of an adjustable dam to decrease the contact angle.

### Embodiment 22

The method of any one of embodiments 15-19, wherein the method can further include decreasing a rate of the liquid transfer by lowering an upper edge of an adjustable dam to increase the contact angle.

### Embodiment 23

The method of embodiment 22, wherein decreasing the rate of liquid transfer can be conducted in response to a trailing end of the substrate approaching the roller.

### Embodiment 24

The method of any one of embodiments 20-23, wherein a quantity of the liquid from the reservoir can continuously spill over the upper edge of the adjustable dam.

### Embodiment 25

The method of any one of embodiments 15-24, wherein changing the elevation of the free surface can include either one or both of varying a fill rate of an incoming liquid filling the reservoir and varying an exiting rate of an outgoing liquid leaving the reservoir.

### Embodiment 26

The method of any one of embodiments 15-25, wherein the substrate may include glass.

### Embodiment 27

The method of any one of embodiments 15-26, wherein the liquid may include an etchant.

### Embodiment 28

A method of coating a substrate can include filling a reservoir of a container with a liquid. A free surface of the liquid can extend over an upper edge of an adjustable dam. A quantity of the liquid from the reservoir can continuously spill over the upper edge of the adjustable dam. The method can further include contacting a portion of an outer periphery of a roller with the liquid at a contact angle. The method can also include adjusting the upper edge of the adjustable dam to change an elevation of the free surface of the liquid within the reservoir to change the contact angle. The method can further include rotating the roller about a rotation axis to transfer liquid from the reservoir to a major surface of the substrate.

### Embodiment 29

The method of embodiment 28, wherein rotating the roller can lift the transferred liquid from the reservoir to contact the major surface of the substrate.

### Embodiment 30

The method of embodiment 28 or embodiment 29, wherein the major surface of the substrate can be spaced above the free surface and can face the free surface.

### Embodiment 31

The method of any one of embodiments 28-30, wherein the contact angle may be from 90° to less than 180°.

### Embodiment 32

The method of any one of embodiments 28-31, wherein a portion of the transfer liquid can space the substrate from contacting the roller while transferring the liquid from the reservoir to the major surface of the substrate.

### Embodiment 33

The method of any one of embodiments 28-32, wherein the method can further include increasing a rate of the liquid transfer by raising the upper edge of the adjustable dam to decrease the contact angle.

### Embodiment 34

The method of any one of embodiments 28-32, wherein the method can further include decreasing a rate of the liquid transfer by lowering the upper edge of the adjustable dam to increase the contact angle.

### Embodiment 35

The method of embodiment 34, wherein decreasing the rate of liquid transfer can be conducted in response to a trailing end of the substrate approaching the roller.

### Embodiment 36

The method of any one of embodiments 28-35, wherein changing the elevation of the free surface can further include either one or both of varying a fill rate of an incoming liquid filling the reservoir and varying an exiting rate of an outgoing liquid leaving the reservoir.

### Embodiment 37

The method of any one of embodiments 28-36, wherein the substrate may include glass.

### Embodiment 38

The method of any one of embodiments 28-37, wherein the liquid may include an etchant.

### BRIEF DESCRIPTION OF THE DRAWINGS

These and other features, embodiments and advantages are better understood when the following detailed description is read with reference to the accompanying drawings, in which:

FIG. 1 illustrates a schematic view of a substrate coating apparatus in accordance with embodiments of the disclosure;

FIG. 2 is a schematic cross-sectional view of the substrate coating apparatus along line 2-2 of FIG. 1 with an adjustable dam at an extended orientation to provide the free surface at an upper elevation;

FIG. 3 illustrates an enlarged view of the substrate coating apparatus at view 2 of FIG. 1 with the free surface of the liquid at the upper elevation;

FIG. 4 illustrates a schematic cross-sectional view of the substrate coating apparatus similar to FIG. 2 but showing the adjustable dam at a retracted orientation to provide the free surface at the lower elevation;

FIG. 5 illustrates an enlarged view of the substrate coating apparatus similar to FIG. 3 but showing the free surface of the liquid at the lower elevation; and

FIGS. 6-11 illustrate an embodiment of a method of coating a substrate as the substrate is traversed over a series of rollers.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

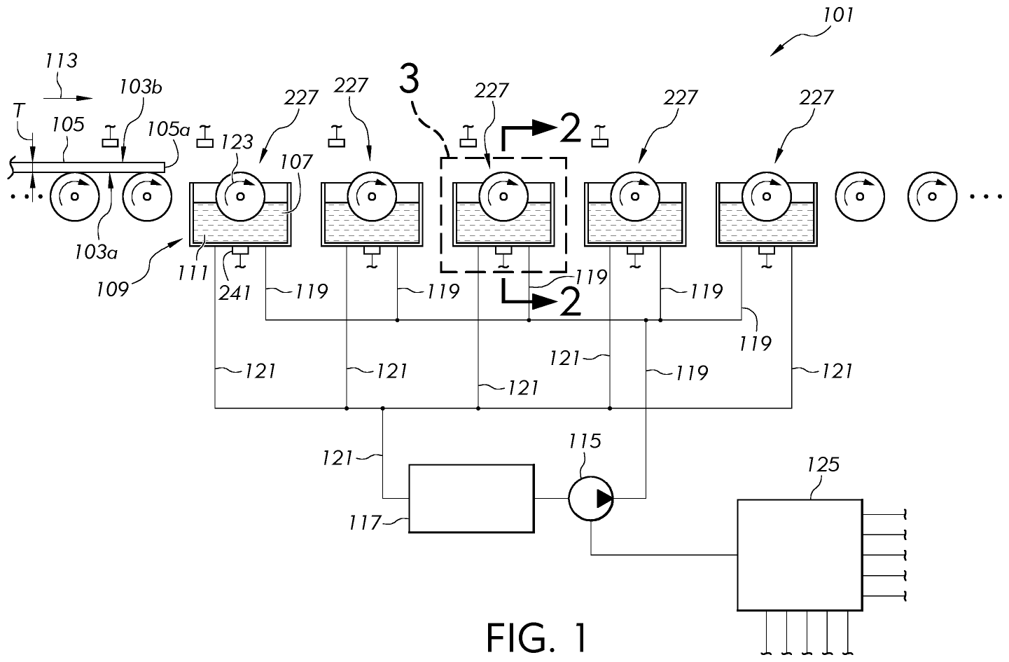

FIG. 1 is a schematic view of a substrate coating apparatus 101 in accordance with embodiments of the disclosure. The substrate coating apparatus 101 can coat a first major surface 103a of a substrate 105 with liquid 107. As shown, the substrate 105 can further include a second major surface 103b that opposes the first major surface 103a. A thickness “T” of the substrate 105 can be defined between the first major surface 103a and the second major surface 103b. A wide range of thicknesses may be provided depending on the particular application. For example, the thickness “T” can comprise substrates having a thickness of from about 50 micrometers (microns, μm) to about 1 centimeter (cm), such as from about 50 microns to about 1 millimeter (mm), such as from about 50 microns to 500 microns, such as from about 50 microns to 300 microns.

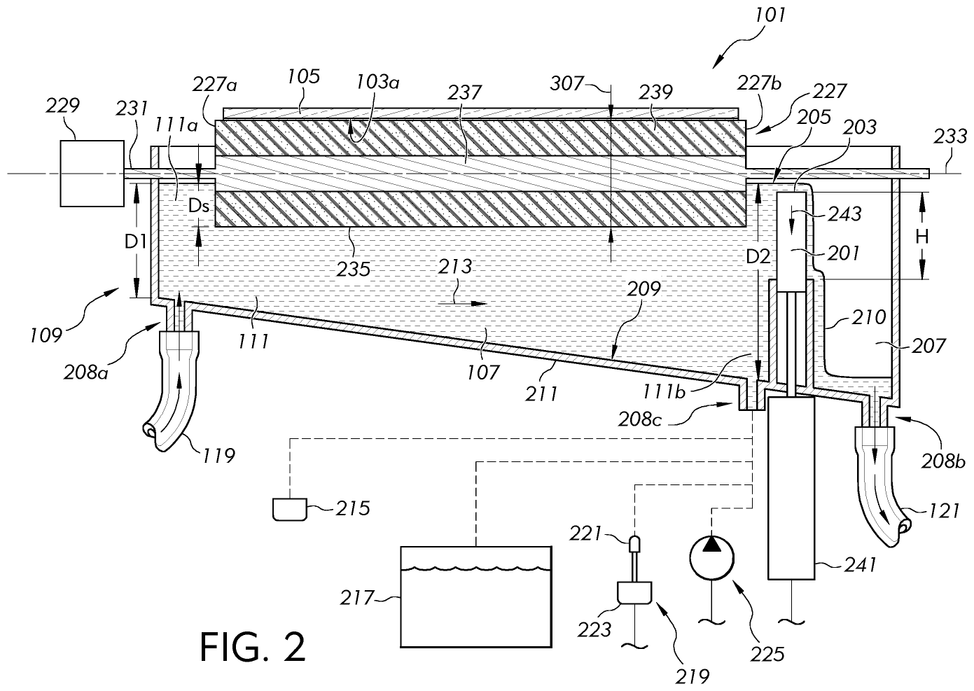

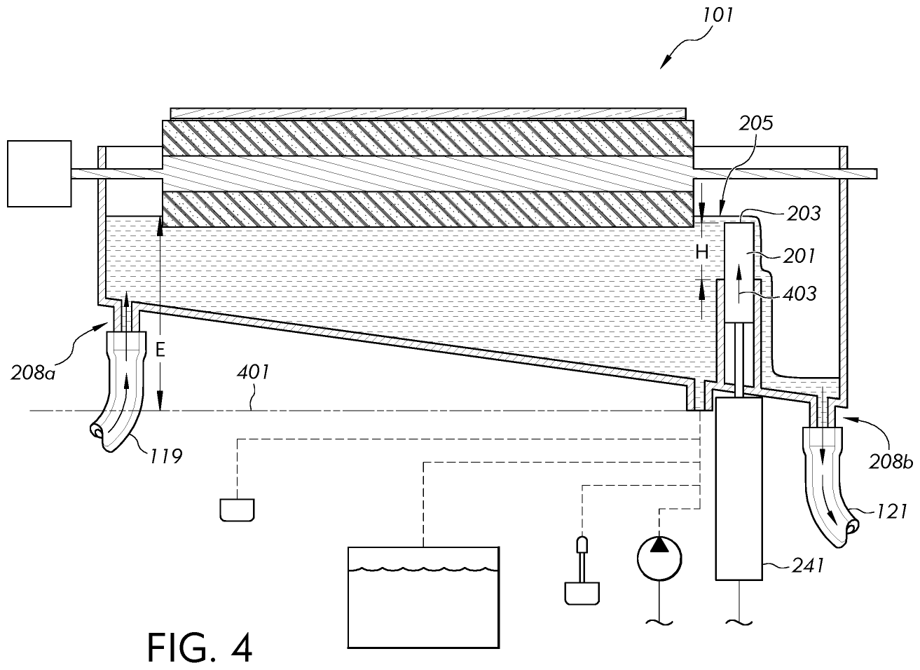

As shown, the thickness “T” of the substrate 105 can be substantially constant along a length of the substrate 105 (see FIG. 1), such as the entire length of the substrate 105 (see FIGS. 6-8). As further shown in FIGS. 2 and 4, the thickness “T” of the substrate 105 can be substantially constant along a width of the substrate 105 that can be perpendicular to the length. As further shown, the thickness “T” of the substrate 105 can be substantially constant along the entire width of the substrate 105. In some embodiments, the thickness “T” can be substantially constant along the entire length and the entire width of the substrate 105. Although not shown, in further embodiments, the thickness “T” of the substrate 105 may vary along a length and/or width of the substrate 105. For instance, thickened edge portions (edge beads) may exist at outer opposed edges of the width that can result from the formation process of some substrates (e.g., glass ribbon). Such edge beads typically include a thickness that may be greater than a thickness of a high quality central portion of the glass ribbon. However, as shown, in FIGS. 2 and 4, such edge beads, if formed with the substrate 105, have already been separated from the substrate 105.

As shown in FIGS. 6-8, the substrate 105 can include a sheet including a leading end 105a and a trailing end 105b wherein the length of the substrate 105 extends between the leading end 105a and the trailing end 105b. In further embodiments, the substrate 105 can comprise a ribbon that can be provided from a source of ribbon. In some embodiments, the source of ribbon can comprise a spool of ribbon that may be uncoiled to be coated by the substrate coating apparatus 101. For instance, the ribbon can be continuously uncoiled from a spool of ribbon while downstream portions of the ribbon are coated with the substrate coating apparatus 101. Further, subsequent downstream processes (not shown), may separate the ribbon into sheets or may eventually coil the coated ribbon on a storage spool. In further embodiments, the source of ribbon can comprise a forming device that forms the substrate 105. In such embodiments, the ribbon can be continuously drawn from the forming device and coated with the substrate coating apparatus 101. Subsequently, in some embodiments the coated ribbon may then be separated into one or more sheets. Alternatively, the coated ribbon may be subsequently coiled on a storage spool.

In some embodiments, the substrate 105 can include silicon (e.g., silicon wafer or silicon sheet), resin, or other materials. In further embodiments, the substrate 105 can include lithium fluoride (LiF), magnesium fluoride (MgF₂), calcium fluoride (CaF₂), barium fluoride (BaF₂), sapphire (Al₂O₃), zinc selenide (ZnSe), germanium (Ge) or other materials. In still further embodiments, the substrate 105 can comprise glass (e.g, aluminosilicate glass, borosilicate glass, soda-lime glass, etc.), glass-ceramic or other materials including glass. In some embodiments, the substrate 105 can include a glass sheet or a glass ribbon, and may be flexible with a thickness “T” of from about 50 microns to about 300 microns, although other range thicknesses and/or nonflexible configurations may be provided in further embodiments. In some embodiments, the substrate 105 (e.g., including glass or other optical material) may be used in various display applications such as liquid crystal displays (LCDs), electrophoretic displays (EPD), organic light emitting diode displays (OLEDs), plasma display panels (PDPs), or other applications.

The substrate coating apparatus 101 may be used to coat various types of liquid 107 on the first major surface 103a of a substrate 105 depending on the desired attributes. For instance, in some embodiments, the coating may comprise a paint, detergent, laminate, surface treatment, sealant, rinsing agent (e.g., water), chemical strengthening material, protectant material or other coating material. In further embodiments, the coating may comprise an etchant designed to etch the first major surface 103a of the substrate 105. The etchant can include a material etchant designed to etch the particular material forming the first major surface 103a of the substrate 105. In some embodiments, the etchant can comprise a glass etchant to etch a substrate 105 including glass at the first major surface 103a. In further embodiments, the etchant may comprise an etchant suitable to etch a substrate 105 including silicon at the first major surface 103a. In further embodiments, the etchant may be designed to etch away unmasked areas of the first major surface 103a of the substrate 105. Indeed, in some embodiments, the etchant may be designed to etch away unmasked portions of an electrically conductive layer on a silicon wafer to form a semiconductor. In further embodiments, the etchant may be designed to provide a desired surface roughness of the first major surface 103a of the substrate 105 (e.g., a desired surface roughness to a glass substrate). For instance, an unmasked portion or the entire first major surface 103a of the substrate 105 may be etched to roughen the surface, thereby preventing undesired direct bonding (such as covalent bonding) between two substrates surfaces contacting one another. In further embodiments, etching may be used to modify optical properties of the substrate 105 or an unmasked portion of the substrate 105 being etched. Furthermore, etching may be used to reduce the thickness “T” of the substrate 105, clean the first major surface 103a of the substrate 105, or to provide other attributes.

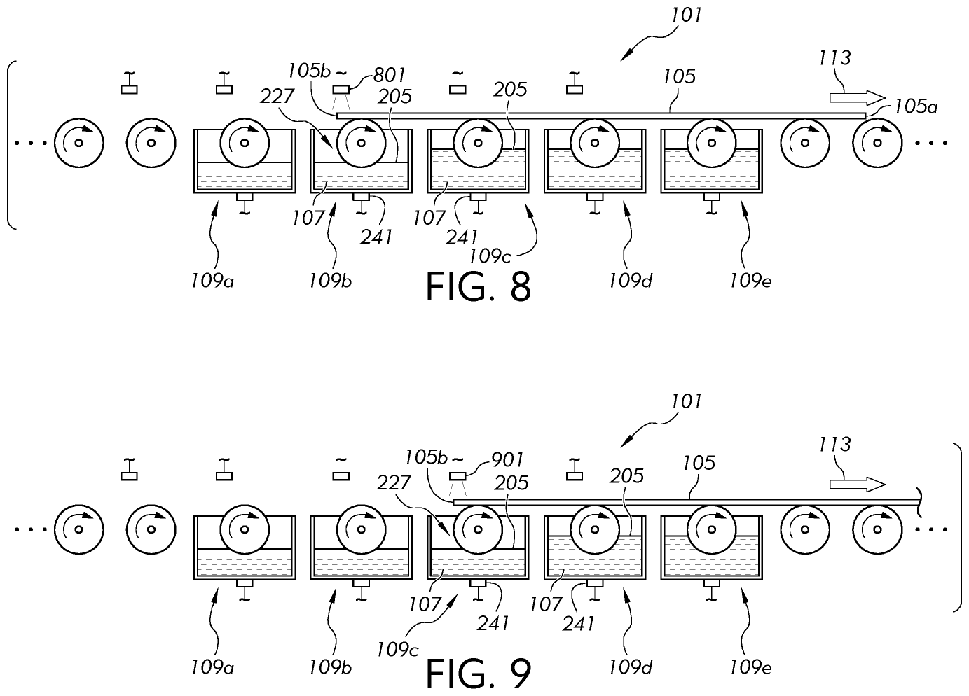

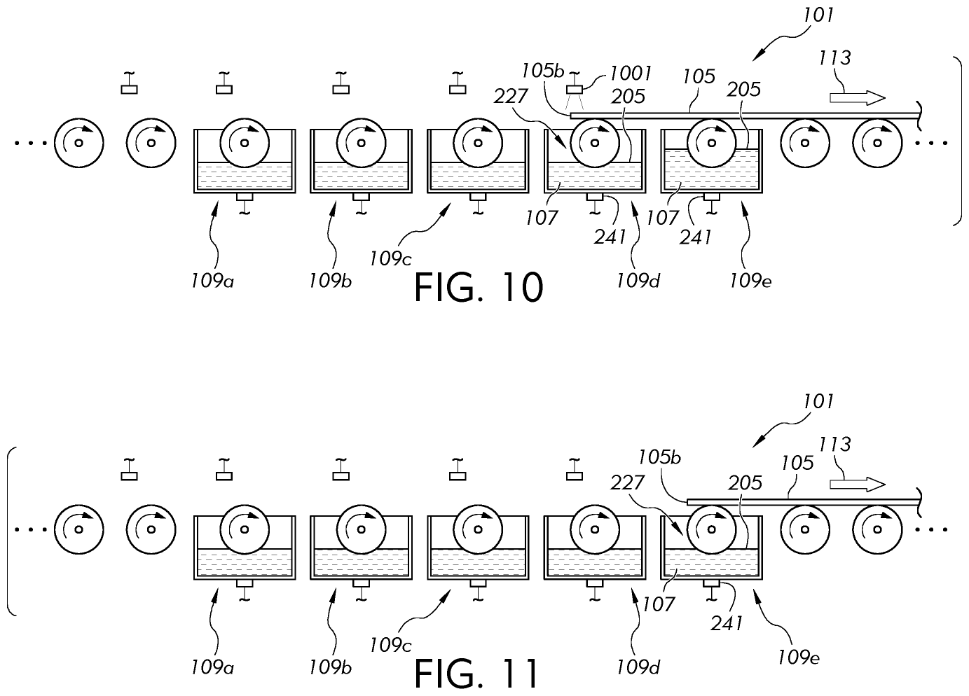

The substrate coating apparatus 101 further includes a container 109 comprising a reservoir 111 wherein liquid 107 may be contained within the reservoir 111 of the container 109. As shown in FIG. 1, the substrate coating apparatus 101 can include a plurality of containers 109 (see also 109a-e in FIGS. 6-11) arranged in series along a conveyance direction 113 of the substrate 105. Although a single container 109 may be provided in non-illustrated embodiments, a plurality of containers 109 can increase the response time of changing an elevation of the liquid 107 within the reservoir 111 and can also permit selective coating rates for different portions of the substrate 105 traveling along the conveyance direction 113.

Referring to FIG. 2, the container 109 can further include an adjustable dam 201 including an upper edge 203. As shown, the reservoir 111 can include a first end portion 111a and a second end portion 111b opposed to the first end portion 111a. As shown, the second end portion 111b of the reservoir 111 can be at least partially defined by the adjustable dam 201. Indeed, as shown, the adjustable dam 201 can act as at least a portion of a containment wall 211 of the container 109 wherein an elevation of the free surface 205 of the liquid 107 within the reservoir 111 may be adjusted by adjusting a height “H” (see FIGS. 2 and 4) of the adjustable dam 201. Indeed, the free surface 205 of the liquid 107 can extend over the upper edge 203 of the adjustable dam 201 and can thereafter spill over the adjustable dam 201 into an overflow containment area 207.

The substrate coating apparatus 101 can further include an inlet port 208a that opens into the first end portion 111a of the reservoir 111. As shown, the inlet port 208a may provide a liquid inlet path through a containment wall 211 of the container 109. Alternatively, although not shown, the inlet port 208a may comprise a port located above the free surface 205 that pours liquid 107 or otherwise introduces liquid 107 to the reservoir 111. As shown in FIG. 1, a pump 115 may drive liquid 107 from a supply tank 117 through an inlet conduit 119 connected to the inlet port 208a that may be associated with each reservoir 111. In operation, the pump 115 may continuously pump liquid 107 to flow from the inlet conduit 119 into the first end portion 111a of the reservoir 111. As shown in FIG. 2, excess liquid 107 may then flow over the upper edge 203 of the adjustable dam 201 and then spill as an overflow stream of liquid 210. Optionally, the overflow containment area 207 may collect the overflow stream of liquid 210 that can continuously spill over the adjustable dam 201 throughout the process of coating the first major surface 103a of the substrate 105. Optionally, as shown in FIG. 2, the adjustable dam 201 may be positioned between an outlet port 208b and the inlet port 208a. Indeed, the adjustable dam 201 provides an obstruction to liquid 107 between the inlet port 208a and outlet port 208b. As the adjustable dam 201 may be positioned between the inlet port 208a and the outlet port 208b, only the liquid 107 spilling (e.g., continuously spilling) over the upper edge 203 of the adjustable dam 201 may reach the outlet port 208b from the inlet port 208a.

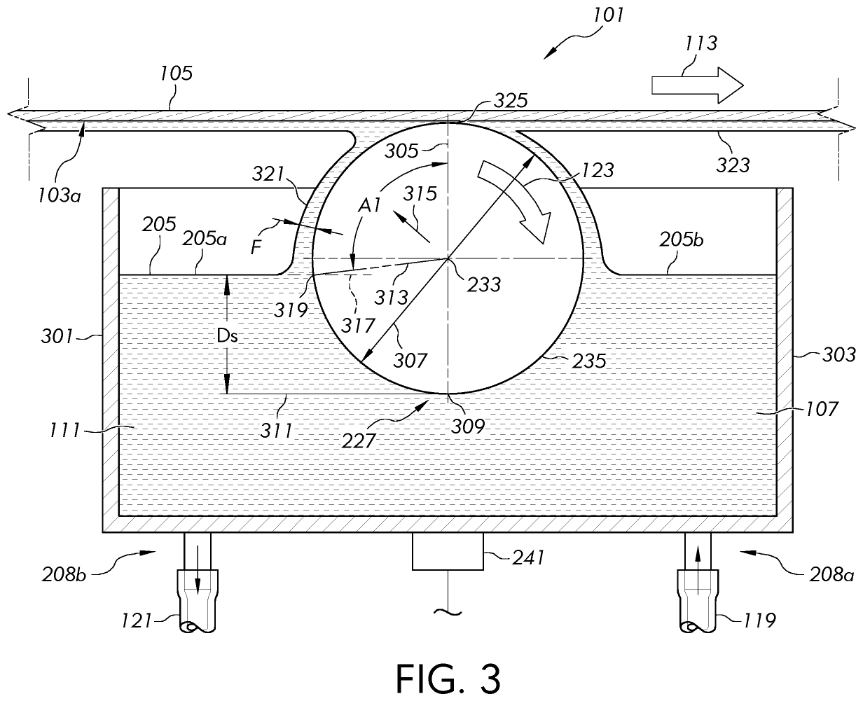

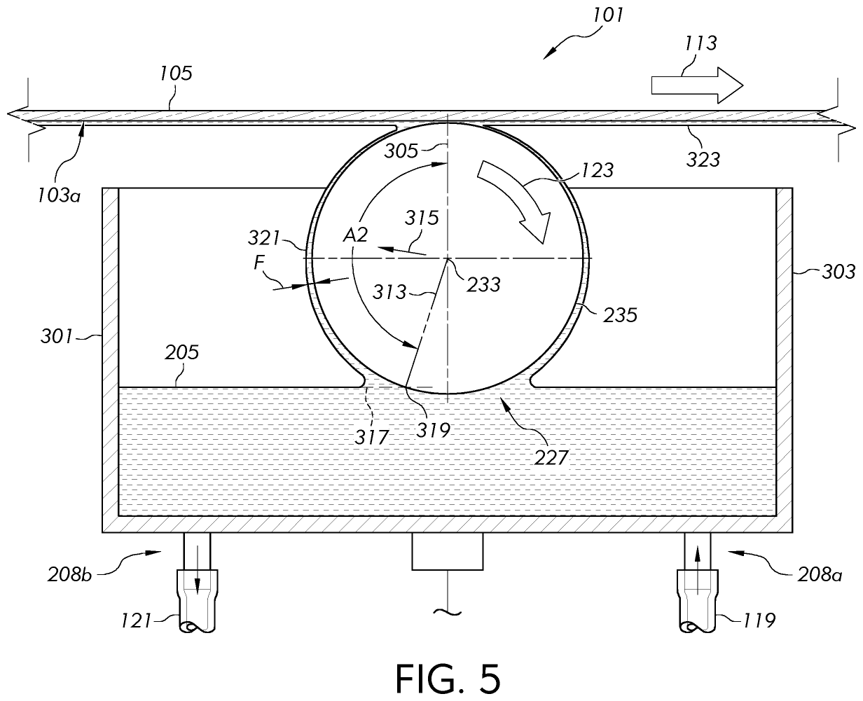

An outlet conduit 121 may be connected to the outlet port 208b that may be associated with each reservoir 111. In operation, liquid may be gravity fed or otherwise returned from the outlet port 208b to the supply tank 117 by way of the outlet conduit 121. As shown in FIG. 2, the outlet port 208b may be positioned downstream from the inlet port 208a such that liquid 107 may flow within the reservoir 111 in direction 213 from the inlet port 208a to the outlet port 208b. FIGS. 3 and 5 schematically illustrate the outlet port 208b positioned closer to a first sidewall 301 than a second sidewall 303 while the inlet port 208a can be positioned closer to the second sidewall 303 than the first sidewall 301. In further embodiments, the inlet port 208a, outlet port 208b and/or outlet port 208c may be positioned along a vertical plane 305 and may optionally pass through a midpoint between the first sidewall 301 and the second sidewall 303.

In some embodiments, the substrate coating apparatus 101 may include another outlet port 208c that opens into the second end portion 111b of the reservoir 111. As shown, the outlet port 208c may be provided with a liquid path through the containment wall 211 of the container 109. As shown schematically in FIG. 2, the outlet port 208c, if provided, may optionally be provided with a cap 215 designed to plug the outlet port 208c to prevent exiting of liquid 107 from the reservoir 111. Alternatively, the outlet port 208c may be provided with a collection vessel 217 to drain the liquid 107 from the reservoir 111. Indeed, after a sufficient time of use, there may be a desire to flush the system to remove all of the liquid 107 from the container 109. In one embodiment, to flush the system, the cap 215 may be removed from the outlet port 208c and liquid 107 may drain out of the container 109 into the collection vessel 217 for disposal or recycling.

In still further embodiments, a transducer apparatus 219 may be provided with a transducer 221 and a cap 223. The transducer 221 may be inserted into the reservoir 111 and secured in place by a cap 223 that engages the outlet port 208c to prevent draining of the liquid 107 from the reservoir 111. The transducer 221 can emit ultrasonic waves through the liquid 107 to enhance coating of the first major surface 103a of the substrate 105 and/or enhance the functionality achieved with coating the first major surface 103a of the substrate 105 with the liquid 107 from the reservoir 111.

In further embodiments, a pump 225 may be connected to the outlet port 208c to pulse or otherwise introduce liquid 107 through the outlet port 208c. Introducing liquid 107 (e.g., pulsing liquid 107) through the outlet port 208c can enhance liquid 107 mixing and/or flow characteristics within the reservoir 111.

As the adjustable dam 201 may provide an adjustable elevation, the liquid 107 may be provided with an adjustable depth D1, D2. For purposes of this application, the depth of the liquid 107 is considered defined between a location of a free surface 205 of the liquid 107 and a corresponding location of a lower inner surface 209 of a containment wall 211 of the container 109 at least partially defining a lower extent of the reservoir 111 wherein the corresponding location of the lower inner surface 209 is aligned with the location of the free surface 205 in a direction of gravity. In some embodiments, as shown in FIG. 2, a depth of the liquid 107 corresponding to an adjusted position of the adjustable dam 201 can increase in a direction 213 from the first end portion 111a to the second end portion 111b from a first depth “D1” of the first end portion 111a to a second depth “D2” of the second end portion 111b that may be greater than the first depth “D1”. In some embodiments, as shown in FIG. 2, the lower inner surface 209 can be inclined downward in the direction of gravity and in the direction 213. Such downward incline in the direction 213, as shown, can be a continuous incline that may be straight (as shown) or curved. In further embodiments, a stepped or other downwardly inclined configuration in the direction 213 may be provided, however a continuous downward incline in the direction 213 may avoid dead spaces where liquid 107 resides without proper circulation within the reservoir 111. The downward incline in the direction 213 can help promote liquid 107 flow in the direction 213 and can also help promote circulation and mixing of liquid 107 within the reservoir 111 compared to embodiments with an upward incline or no incline.

As further shown in FIG. 2, the substrate coating apparatus 101 may further include a roller 227 rotatably mounted relative to the container 109. A drive mechanism 229 may be connected to a rotation shaft 231 that extends along a rotation axis 233 of the roller 227. The drive mechanism 229 may apply torque to the rotation shaft 231 to rotate the roller 227 in direction 123 about the rotation axis 233 (see FIG. 3). The drive mechanism 229 may include a drive motor that may be directly connected to the rotation shaft 231 with a coupling or may be indirectly connected to the rotation shaft by a drive belt or drive chain. In some embodiments, a single drive motor may be provided wherein one or more drive belts or drive chains simultaneously rotate the plurality of rollers 227 at the same rotational velocity about each respective rotation axis 233. Alternatively, individual drive motors may be associated with each respective rotation shaft 231 to allow independent rotation of the rollers 227 relative to one another.

As further illustrated in FIG. 2, in some embodiments, the rotation axis 233 of the roller 227 may extend in the direction 213 from the first end portion 111a to the second end portion 111b. As such, the roller can be oriented with the length of the roller 227 between the first end 227a and the second end 227b of the roller oriented in the direction 213 of liquid flow from the first end portion 111a to the second end portion 111b. Such a lengthwise orientation of the roller 227, as shown, can minimize resistance to liquid flow in the direction 213. Furthermore, as shown in FIG. 3, the free surface 205a at the first side of the roller 227 may be maintained at the same or approximately the same elevation as the free surface 205b at the second side of the roller 227. Providing free surfaces 205a, 205b that are maintained at the same or approximately the same elevation can enhance the functionality of the roller in lifting liquid 107 from the reservoir 111 to the first major surface 103a of the substrate 105.

As shown in FIG. 2, an outer periphery 235 of the roller 227 can be defined by a porous material. The porous material can include a closed-cell porous material, although open-cell porous material may readily absorb a quantity of liquid to enhance the liquid transfer rate from the reservoir 111 to the first major surface 103a of the substrate 105. The material defining the outer periphery 235 of the roller 227 can comprise a rigid or flexible material made from polyurethane, polypropylene or other material. Furthermore, in some embodiments, the outer periphery of the roller 227 may be smooth without pores or other surface discontinuities. In further embodiments, the outer periphery of the roller 227 may be patterned with detents, grooves, knurls or other surfaced patterns. In still further embodiments, the outer periphery may include a roller nap of fabric and/or may include protrusions such as fibers, bristles, or filaments.

In some embodiments, the roller 227 may comprise a monolithic cylinder of continuous composition and configuration throughout the entire roller. In further embodiments, as shown, the roller 227 may include an inner core 237 and an outer layer 239 disposed on the inner core 237 that defines the outer periphery 235 of the roller 227. As shown, the inner core 237 can comprise a solid inner core, although a hollow inner core maybe provided in further embodiments. The inner core can facilitate transfer of torque to rotate the roller 227 while the outer layer 239 can be fabricated of material designed to provide desired lifting of liquid 107 from the reservoir and coating of the liquid on the first major surface 103a of the substrate 105.

With reference to FIG. 3, the diameter 307 of the roller 227 can be from about 20 mm to about 50 mm, although rollers with other diameters may be provided in further embodiments. As further illustrated, a portion 309 of the outer periphery 235 of the roller 227 may be disposed within the adjustable depth of the liquid and can extend to a submerged depth “Ds” below the free surface 205 from 0.5 mm to 50% of the diameter 307 of the roller 227. In some embodiments, the submerged depth “Ds” can be from about 0.5 mm to about 25 mm, such as from about 0.5 mm to about 10 mm, although other submerged depths may be provided in further embodiments. Submerged depth “Ds”, for purposes of this application, is considered the depth that the lowest portion of the roller 227 extends below the free surface 205. As shown in FIG. 3, the submerged depth “Ds” is the distance that a maximum depth plane 311 is offset from the free surface 205 wherein the maximum depth plane 311 is parallel to the free surface 205 and extends tangent to the lowest point of the illustrated circular cylindrical roller 227.

As further illustrated in FIGS. 3 and 5, the roller 227 contacts the liquid 107 at a wide range of contact angles A1, A2. In some embodiments, the contact angle A1, A2 can be from 90° to less than 180° to provide desired liquid transfer rates from the reservoir 111 to the first major surface 103a of the substrate 105. For purposes of this application, the contact angle is considered the angle, facing a direction 315 toward the first major surface 103a of the substrate, between a contact plane 313 and a vertical plane 305 passing through the rotation axis 233 of the roller 227. For purposes of the disclosure, the contact plane 313 is considered the plane intersecting the rotation axis 233 and an intersection line 319 of an extension 317 of the elevation of the free surface 205 and the outer periphery 235 of the roller 227. Indeed, as shown in FIGS. 3 and 5, the extension 317 of the free surface 205 intersects the outer periphery 235 of the roller 227 at the intersection line 319. The contact plane 313 is considered the plane including the intersection line 319 and the rotation axis 233. As shown in FIG. 3, the free surface 205a, 205b can be the same on each side of the roller 227. Thus, the contact angle at each side of the roller 227 can be identical to one another. In further embodiments, two different contact angles may be provided on each side of the roller 227 if the free surfaces 205a, 205b are at different elevations.

Methods of coating the substrate 105 will now be described. A method of coating the substrate 105 can include filling the reservoir 111 of the container 109 with liquid 107 (e.g., etchant). In some embodiments, filling the reservoir 111 may include introducing the liquid through the inlet port 208a. In further embodiments, the pump 115 may provide liquid from a supply tank 117 to the inlet port 208a by way of the inlet conduit 119. In some embodiments, the reservoir 111 of the container 109 may be continuously filled with liquid 107 while coating the first major surface 103a of the substrate 105 with the liquid transferred to the first major surface 103a with the roller 227.

Methods of coating the substrate 105 can also include contacting a portion of the outer periphery 235 of the roller 227 with the liquid 107 at the contact angle A1, A2. In some embodiments, as shown in FIGS. 3 and 5, the contact angle may be from 90° to less than 180°. Methods can also include changing the elevation of the free surface 205 of the liquid 107. For purposes of this application, with reference to FIG. 4, the elevation “E” of the free surface 205 of the liquid 107 is considered relative to a reference elevation 401 that is lower than the elevation of the free surface 205 at any possible adjusted elevation. In embodiments where any adjusted elevation of the free surface 205 is always above sea level, the reference elevation 401 can optionally be considered sea level.

Methods of changing the elevation can be achieved in a wide variety of ways. For instance, changing the elevation “E” of the free surface 205 can include varying a fill rate of an incoming liquid filling the reservoir 111 (e.g., by way of inlet port 208a) and/or varying an exiting rate of an outgoing liquid leaving the reservoir (e.g., by way of the adjustable dam 201). In further embodiments, an increased response time with a higher degree of level change of the liquid elevation “E” can be achieved with the adjustable dam 201. Accordingly, any of the embodiments of the disclosure can include adjusting the liquid elevation “E” by adjusting the adjustable dam 201.

The method of changing the liquid elevation “E” with the adjustable dam 201 can include filling the reservoir, such as continuously filling the reservoir, while the free surface 205 of the liquid extends over the upper edge 203 of the adjustable dam 201. The quantity of liquid 210 from the reservoir 111 continuously spills over the upper edge 203 of the adjustable dam 201. To rapidly decrease the elevation of the free surface 205 shown in FIG. 2, an actuator 241 may retract the adjustable dam 201 in downward direction 243 to cause the upper edge 203 to move from the upper position shown in FIG. 2 to the lower position shown in FIG. 4. In response to the relatively quick retraction of the adjustable dame 201, the elevation of the free surface 205 may be quickly lowered to the elevation “E” shown in FIG. 4.

Referring to FIG. 4, if there is a desire to increase the elevation “E” of the free surface 205, the actuator 241 may extend the adjustable dam 201 in the upward direction 403 from the lower position shown in FIG. 4 to the upper position shown in FIG. 2. Consequently, the continuous filling of the liquid 107 into the reservoir (e.g., by way of inlet port 208a) continues filling the reservoir 111, thereby increasing the elevation “E” of the free surface 205 of the liquid 107 until steady state is achieved wherein the liquid continuously spills over the adjustable dam 201 as shown in FIG. 2.

Changing the elevation “E” of the free surface 205 consequently changes the contact angle A1, A2. Indeed, extending the adjustable dam 201 to the upper position shown in FIG. 2 increases the elevation “E” of the free surface 205 to decrease the contact angle to “A1” as shown in FIG. 3. The relatively small contact angle “A1” can provide a relatively high rate of liquid transfer from the reservoir 111 to the first major surface 103a of the substrate 105. On the other hand, retracting the adjustable dam 201 to the lower position shown in FIG. 4 decreases the elevation “E” of the free surface 205 to increase the contact angle to “A2” shown in FIG. 5. The relatively large contact angle “A2” can provide a relatively low rate of liquid transfer from the reservoir 111 to the first major surface 103a of the substrate 105.

The method can further include rotating the roller 227 about the rotation axis 233 to transfer liquid from the reservoir 111 to the first major surface 103a of the substrate 105. As shown in FIG. 3, for example, the roller 227 can rotate in direction 123 to promote translation of the substrate 105 in direction 113 while lifting transferred liquid 321 from the reservoir 111 to contact and thereby coat the first major surface 103a of the substrate 105 with a layer 323 of the transferred liquid 321. In the illustrated embodiment, the first major surface 103a of the substrate 105 may be spaced above the free surface 205 of the liquid 107 and faces the free surface 205. In further embodiments, the roller 227 may not mechanically contact the first major surface 103a of the substrate 105. Rather, as shown in FIG. 3, a portion 325 of the transfer liquid can space the substrate 105 from contacting the roller 227 while transferring the liquid 321 from the reservoir 111 to the first major surface 103a of the substrate 105. Consequently, substrate 105 can float on the portions 325 of the transfer liquid on top of each roller 227 as the substrate 105 may be coated and translated along direction 113.

As set forth above, the rate of liquid transfer can be increased by raising the upper edge 203 of the adjustable dam 201 to decrease the contact angle. Indeed, in the extended position shown in FIG. 2, the adjustable dam 201 causes the free surface to rise to the elevation illustrated in FIGS. 2 and 3. With the decreased contact angle “A1” shown in FIG. 3, the film thickness “F” of the layer of transfer liquid 321 being lifted on the outer periphery 235 of the roller 227 may be relatively thick compared to higher contact angles. As such, as shown in FIG. 3, an increased transfer rate of transfer liquid 321 may be achieved from the reservoir 111 to the first major surface 103a of the substrate 105. In such examples, as shown in FIG. 3, a relatively thick layer 323 of transferred liquid 321 may be coated on the first major surface 103a of the substrate 105.

As further set forth above, the rate of liquid transfer can be decreased by lowering the upper edge 203 of the adjustable dam 201 to increase the contact angle. Indeed, in the retracted position shown in FIG. 4, the adjustable dam 201 causes the free surface to lower to the elevation illustrated in FIGS. 4 and 5. With the increased contact angle “A2” shown in FIG. 5, the film thickness “F” of the layer of transfer liquid 321 being lifted on the outer periphery 235 of the roller 227 may be relatively thin compared to smaller contact angles. As such, as shown in FIG. 5, a decreased transfer rate of transfer liquid 321 may be achieved from the reservoir 111 to the first major surface 103a of the substrate 105. In such examples, as shown in FIG. 5, a relatively thin layer 323 of transferred liquid 321 may be coated on the first major surface 103a of the substrate 105.

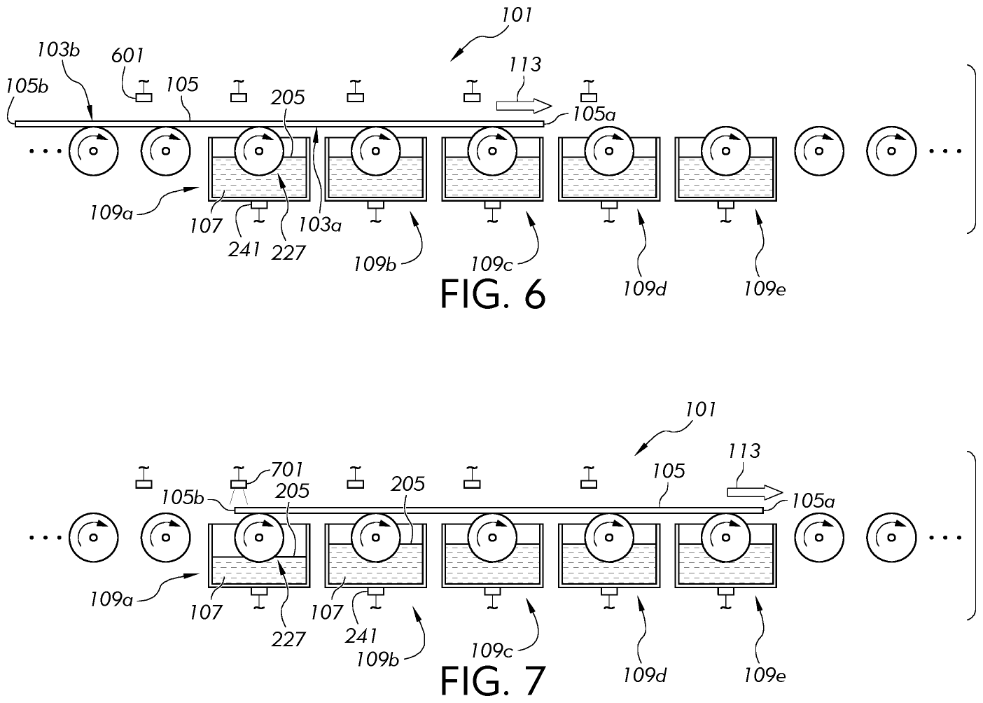

Increasing or decreasing the transfer rate of the transfer liquid can be beneficial to allow selective coating of different portions of the substrate 105. For example, FIGS. 6-11 show examples where decreasing the rate of liquid transfer may be conducted in response to the trailing end 105b of the substrate 105 approaching the roller 227. As schematically shown in FIGS. 6-11, the substrate coating apparatus 101 may include a plurality of sensors 601, 701, 801, 901, 1001 spaced apart from one another along a travel path of the substrate 105 traveling in direction 113. As shown in FIG. 6, the trailing end 105b approaches and may be eventually detected by a first sensor 601. The first sensor 601 can then send a signal through a communication path to a controller 125 (see FIG. 1). In response, the controller 125 can send a signal to the actuator 241 that retracts the adjustable dam 201 of a first container 109a in downward direction 243 from the position shown in FIG. 2 to the retracted position shown in FIG. 4. In response, the elevation “E” of the free surface 205 of the liquid 107 within the first container 109a quickly drops from the elevation shown in FIG. 6 to the elevation shown in FIG. 7. Due to the quick drop in elevation “E”, the contact angle increases (e.g., to A2), thereby decreasing the rate at which transfer liquid 321 is lifted from the reservoir 111 to the first major surface 103a of the substrate as the trailing end 105b passes over the roller 227 associated with the first container 109a. A decrease in the transfer rate of transfer liquid 321 can decrease splatter of liquid that may otherwise undesirably land on the second major surface 103b of the substrate 105 as the trailing end 105b passes over the roller 227 associated with the first container 109a. As such, the roller can provide an increased transfer rate of transfer liquid 321 associated with a relatively small contact angle “A1” to provide adequate coating by the rollers of the first major surface 103a while also providing a relatively large contact angle “A1” to reduce the rate at which transfer liquid 321 is lifted by the roller 227 as the trailing end 105b passes over the roller to avoid undesirable spattering of the liquid to the second major surface 103b of the substrate 105.

As shown in FIG. 7 the trailing end 105b then approaches and may be eventually detected by a second sensor 701. The second sensor 701 can then send a signal through a communication path to the controller 125. In response, the controller 125 can send a signal to the actuator 241 that retracts the adjustable dam 201 of a second container 109b in downward direction 243 from the position shown in FIG. 2 to the retracted position shown in FIG. 4. In response, the elevation “E” of the free surface 205 of the liquid 107 within the second container 109b quickly drops from the elevation shown in FIG. 7 to the elevation shown in FIG. 8. Due to the quick drop in elevation “E”, the contact angle increases (e.g., to A2), thereby decreasing the rate at which transfer liquid 321 is lifted from the reservoir 111 to the first major surface 103a of the substrate as the trailing end 105b passes over the roller 227 associated with the second container 109b. A decrease in the transfer rate of transfer liquid 321 can decrease splatter of liquid that may undesirably land on the second major surface 103b as the trailing end 105b passes over the roller 227 associated with the second container 109b.

In a similar manner, as demonstrated in FIGS. 8-11, the trailing end 105b then sequentially approaches and may be eventually sequentially detected by sensors 801, 901, 1001. The sensors 801, 901, 1001 can then send corresponding signals through communication paths to the controller 125. In response to each sequential signal, the controller 125 can send sequential signals, respectively, to the actuator 241 associated with each of the third, fourth and fifth containers 109c, 109d, 109e to sequentially retract the adjustable dams 201 of the third, fourth and fifth containers 109c, 109d, 109e. The adjustable dams 201 are then retracted, sequentially, in the downward direction 243 from the position shown in FIG. 2 to the retracted position shown in FIG. 4. In response, the elevation “E” of the free surface 205 of the liquid 107 quickly drops sequentially within the third, fourth and fifth containers. Due to the quick drop in elevation “E”, the contact angle increases (e.g., to A2), thereby decreasing the rate at which transfer liquid 321 is lifted from the reservoir 111 to the first major surface 103a of the substrate as the trailing end 105b of the substrate 105 passes over each sequential roller 227 associated with each sequential container 109c, 109d, 109e. A decrease in the transfer rate of transfer liquid 321 can decrease splatter of liquid that may undesirably land on the second major surface 103b as the trailing end 105b passes over the corresponding roller 227 associated with each of the containers 109c, 109d, 109e.

Although not shown, once the trailing end 105b of the substrate 105 passes over the roller 227, the adjustable dam 201 may again be extended to the position shown in FIG. 4 to raise the elevation of the free surface 205 of the liquid to provide increased liquid transfer rate in preparation for a return of the substrate in a direction opposite direction 113 or in preparation of receiving a new substrate. Indeed, the substrate may be passed back and forth along direction 113 and in a direction opposite 113 to achieve the desired coating or treatment of the first major surface 103a of the substrate 103. In etching applications, new etchant may be applied during each successive pass to provide additional etching during each pass (with possible rinsing or other processing intermediate steps) until the desired level of etching is achieved.

It should be understood that while various embodiments have been described in detail with respect to certain illustrative and specific examples thereof, the present disclosure should not be considered limited to such, as numerous modifications and combinations of the disclosed features are possible without departing from the scope of the following claims.

1. A substrate coating apparatus, comprising:
a container comprising a reservoir and an adjustable dam defining an adjustable depth of the reservoir; and
a roller rotatably mounted relative to the container, a portion of an outer periphery of the roller disposed within the adjustable depth of the reservoir.

2. The substrate coating apparatus of claim 1, comprising:
a liquid disposed in the reservoir with a free surface of the liquid extending over an upper edge of the adjustable dam, and the roller contacting the liquid at a contact angle.

3. The substrate coating apparatus of claim 2, wherein liquid comprises an etchant.

4. The substrate coating apparatus of claim 2, wherein adjusting the adjustable dam changes an elevation of the free surface.

5. (canceled)

6. The substrate coating apparatus of claim 2, wherein the portion of the outer periphery of the roller extends to a submerged depth below the free surface from 0.5 mm to 50% of a diameter of the roller.

7. The substrate coating apparatus of claim 1, wherein a diameter of the roller is from about 20 mm to about 50 mm.

8. The substrate coating apparatus of claim 1, wherein the outer periphery of the roller is defined by a porous material.

9. The substrate coating apparatus of claim 1, wherein the reservoir includes a first end portion and a second end portion opposed to the first end portion, and the second end portion is at least partially defined by the adjustable dam.

10. The substrate coating apparatus of claim 9, wherein a depth of the reservoir corresponding to an adjusted position of the adjustable dam increases in a direction from the first end portion to the second end portion.

11. The substrate coating apparatus of claim 9, wherein a rotation axis of the roller extends in a direction from the first end portion to the second end portion.

12.-14. (canceled)

15. A method of coating a substrate, comprising:
filling a reservoir of a container with a liquid;
contacting a portion of an outer periphery of a roller with the liquid at a contact angle;
changing an elevation of a free surface of the liquid within the reservoir to change the contact angle; and
rotating the roller about a rotation axis to transfer liquid from the reservoir to a major surface of the substrate.

16. The method of claim 15, wherein rotating the roller lifts the transferred liquid from the reservoir to contact the major surface of the substrate.

17.-18. (canceled)

19. The method of claim 15, wherein a portion of the transfer liquid spaces the substrate from contacting the roller while transferring the liquid from the reservoir to the major surface of the substrate.

20. The method of claim 15, wherein changing the elevation of the free surface comprises adjusting a height of an adjustable dam.

21. The method of claim 15, further comprising increasing a rate of the liquid transfer by raising an upper edge of an adjustable dam to decrease the contact angle.

22. The method of claim 15, further comprising decreasing a rate of the liquid transfer by lowering an upper edge of an adjustable dam to increase the contact angle.

23. The method of claim 22, wherein decreasing the rate of liquid transfer is conducted in response to a trailing end of the substrate approaching the roller.

24. (canceled)

25. The method of claim 15, wherein changing the elevation of the free surface comprises either one or both of varying a fill rate of an incoming liquid filling the reservoir and varying an exiting rate of an outgoing liquid leaving the reservoir.

26. The method of claim 15, wherein the substrate comprises glass.

27. The method of claim 15, wherein the liquid comprises an etchant.

28.-38. (canceled)
